(19) United States
(12) Patent Application Publication
(10) Pub. No.: US 2013/0330093 A1
(43) Pub. Date: Dec. 12, 2013

(54) IMAGE FORMING APPARATUS

(71) Applicant: Canon Kabushiki Kaisha, Tokyo (JP)

(72) Inventor: Yutaka Kakehi, Kashiwa-shi (JP)

(21) Appl. No.: 13/911,406

(22) Filed: Jun. 6, 2013

(30) Foreign Application Priority Data
Jun. 7, 2012 (JP) 2012-129811

(51) Int. Cl. G03G 15/00

(52) U.S. Cl. CPC G03G 15/2028
USPC 399/16

(57) ABSTRACT

An image forming apparatus including an feeding belt for electrostatically attracting and carrying a sheet having a toner image; an image heating member for heating the toner image while nipping and feeding the sheet; a separation roller for stretching tab sheet feeding belt and for separating the sheet from tab sheet feeding belt and directing the sheet toward to image heater; an electrical discharging member, provided at a position opposing tab separation roller through tab sheet feeding belt therebetween; and a controller for controlling tab discharging device to operate for discharging of the sheet after a leading end of the sheet is brought into abutment to the nip.

### FIELD OF THE INVENTION AND RELATED ART

The present invention relates to an image forming apparatus such as a copying machine, a laser beam printer, etc., which is structured to use an electrophotographic image forming method and transfers a toner image onto a sheet of recording medium.

There have long been put to practical use color image forming apparatuses which form multiple toner images, different in color, on their image bearing members such as photosensitive drums, sequentially transfer (primary transfer) the toner images onto their intermediary transfer medium such as an intermediary transfer belt, and then, transfer together (secondary transfer) the toner images from the intermediary transfer medium, onto a sheet of recording medium. With the employment of an intermediary transfer medium, it is only once that these image forming apparatuses have to transfer the toner images onto a sheet of recording medium which tends to change in condition. Therefore, these image forming apparatuses are stable in their image formation process.

In recent years, the field in which image forming apparatuses are used has rapidly widened. With the widening of the field, demand has been increasing for an image forming apparatus capable of dealing with a sheet of thin paper or the like recording medium which is rather low in rigidity. However, in a case of an image forming operation in which a sheet of thin paper, being therefore low in rigidity, is used as recording medium, the leading edge portion of the sheet of recording medium is likely to be curled (made to bend in curvature (slack), for example) by the friction between the leading edge portion of the sheet and recording medium guides, etc., before the recording medium arrives at the secondary transfer station, and/or the recording medium is likely to be made to fail to arrive at the secondary transfer station on time, by the above described friction, making it sometimes difficult for an image to be reliably transferred onto recording medium.

Thus, there have been proposed various methods to deal with the above described problem. One of such methods is disclosed in Japanese Laid-open Patent Application 2004-133419. According to this patent application, a sheet of recording medium is kept electrostatically adhered to a known recording medium bearing member (recording medium conveyance belt, for example) while the sheet of recording medium is conveyed through the transfer nip.

In the case of an image forming apparatus structured so that a sheet of recording medium is kept electrostatically adhered to the recording medium conveyance belt of the apparatus, and also, so that the sheet of recording medium is pushed into the fixing device of the apparatus by the combination of the secondary transfer roller and recording medium conveyance member, in order to prevent the image forming apparatus from outputting a defective image, the defect of which is attributable to the shock which occurs at the moment when the trailing edge of the sheet of recording medium comes out of the secondary transfer nip of the secondary transfer station while the sheet of recording medium is being pulled by the combination of the fixation roller and pressure roller of the fixing device, the sheet of recording medium is made to slack. As the sheet of recording medium, which is kept electrostatically adhered to the recording medium conveyance belt, increases in curvature (slack), it is forced to peel away from the recording medium conveyance belt, by its curvature (slack), on the upstream side of the normal point of separation between the sheet of recording medium and recording medium conveyance belt in terms of the recording medium conveyance direction.

Thus, as the sheet of recording medium suddenly peels away from the recording medium conveyance belt, the electric charge which is keeping the sheet of recording medium electrostatically adhered to the belt causes electrical discharge (which hereafter will be referred to simply as “separation discharge”) between the sheet and belt. The amount of this electrical discharge is affected by the attitude in which the portion of the sheet, which is being separated from the belt, is. In the case of the image forming apparatus structured so that after the arrival of the leading edge of a sheet of recording medium at the fixation nip of the fixing device, the sheet is made to increase in the slack amount by the thrust given to the sheet by the second transfer station, being thereby forced to suddenly separate from the belt, on the upstream side of the normal point of separation between the sheet and intermediary transfer belt, while remaining electrostatically attracted to the belt, the “separation discharge” or the electrical discharge between the sheet of recording medium and intermediary transfer belt, is strong enough to disturb the unfixed toner image on the sheet. Thus, the image forming apparatus sometimes outputs a low quality image.

One of the thinkable methods for preventing the occurrence of the above described problem is to place a corona-based charge removal device in the adjacencies of where a sheet of recording medium separates from the intermediary transfer belt in order to reduce the electrical charge which causes the “separation discharge”, that is, the electrical charge which is keeping the sheet of recording medium electrostatically adhered to the belt. However, if a corona-based discharging device is used to reduce the electrical charge which keeps the sheet of recording medium electrostatically adhered to the intermediary transfer belt, it ends up reducing the electrostatic force which keeps the sheet of recording medium adhered to the intermediary transfer belt.

As the electrostatic attraction between the sheet of recording medium and intermediary transfer belt reduces, the sheet is likely to unexpectedly separate from the recording medium conveyance belt, making it difficult for the sheet to be reliably conveyed. If a sheet of recording medium does not remain electrostatically adhered to the intermediary transfer belt, it is unstable in attitude. Thus, as it is made to enter the fixing device, it possibly jams the fixing device (image forming apparatus).

### SUMMARY OF THE INVENTION

Thus, the primary object of the present invention is to provide an image forming apparatus structured so that it can reliably control a sheet of recording medium in attitude to prevent the recording medium jam attributable to the wrong attitude of the sheet, and therefore, virtually no electrical discharge occurs between the sheet of recording medium and recording medium conveyance belt when the sheet is separated from the recording medium conveyance belt by the separation roller, or is made to separate from the recording medium conveyance belt by the slack of the sheet, on the upstream side of the normal point of separation between the sheet and the recording medium conveyance belt, in terms of the recording medium conveyance direction, in order to prevent the apparatus from outputting an unsatisfactory image.

According to an aspect of the present invention, there is provided an image forming apparatus comprising an image forming portion for forming a toner image on a recording material; an endless recording material feeding belt for electrostatically attracting and carrying the recording material having a toner image; an image heating member for receiving the recording material from said recording material feeding belt and for heating the toner image on the recording material while nipping and feeding the recording material; a separation roller for stretching said recording material feeding belt and for separating the recording material from said recording material feeding belt and directing the recording material toward said image heating means; an electrical discharging member, provided at a position opposing said separation roller through said recording material feeding belt therebetween, for removing charge of the recording material; and a controller for controlling said discharging means to operate for discharging of the recording material after a leading end of the recording material is brought into abutment to the nip.

According to the present invention, a discharging member is placed in the adjacencies of the recording medium separating means of an image forming apparatus, and the apparatus is controlled in such a manner that the removal of electrical charge from a sheet of recording medium is started after the occurrence of the contact between the leading edge of the sheet and the nip between the image heating member and image pressing member of the fixing device of the apparatus. Therefore, the apparatus can control the sheet of recording medium in attitude to prevent the sheet from jamming the apparatus, in particular, the fixing device. Further, the electrical charge of the sheet of recording medium is removed by the discharging member. Therefore, even when the sheet of recording medium is forced to separate from the recording medium conveyance belt by the increased slack of the sheet P, it is ensured that the “separation discharge” attributable to the attitude in which the sheet is when the sheet is separated from the recording medium conveyance belt, does not occur. Therefore, it is ensured that the image forming apparatus does not output an unsatisfactory image, the unsatisfactoriness of which is attributable to the “separation discharge” which is likely to occur between a sheet of recording medium and the recording medium conveyance belt of the apparatus.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a schematic sectional view of the image forming apparatus in the first embodiment of the present invention, and shows the general structure of the apparatus.

FIG. 2 is a block diagram of the control system of the image forming apparatus in the first embodiment.

FIG. 3 is a flowchart of the operation for controlling the electrical charge of a sheet of recording medium, in the first embodiment.

FIGS. 4(a) and 4(b) are schematic drawings for describing the operation for controlling the electrical charge of a sheet of recording medium, in the first embodiment.

FIG. 5 is a sectional view of the modified version of the portion of the image forming apparatus in the first embodiment, which is essential to the present invention.

FIG. 6 is a block diagram of the operation for controlling the electrical charge of a sheet of recording medium, in the second embodiment of the present invention.

FIG. 7 is a flowchart of the operation for controlling the electrical charge of a sheet of recording medium, in the second embodiment.

FIG. 8 is a schematic sectional view of the portion of the image forming apparatus, in the second embodiment, which is essential to the present invention.

FIG. 9 is a schematic sectional view of an image forming apparatus comparable to those in the first and second embodiment, and shows the general structure of the apparatus.

FIGS. 10(a)-10(c) are schematic drawings for describing the problem which occurs to the image forming apparatus structured as shown in FIG. 9.

### DESCRIPTION OF THE PREFERRED EMBODIMENTS

Hereinafter, embodiments of the present invention are described in detail with reference to the appended drawings.

### Embodiment 1

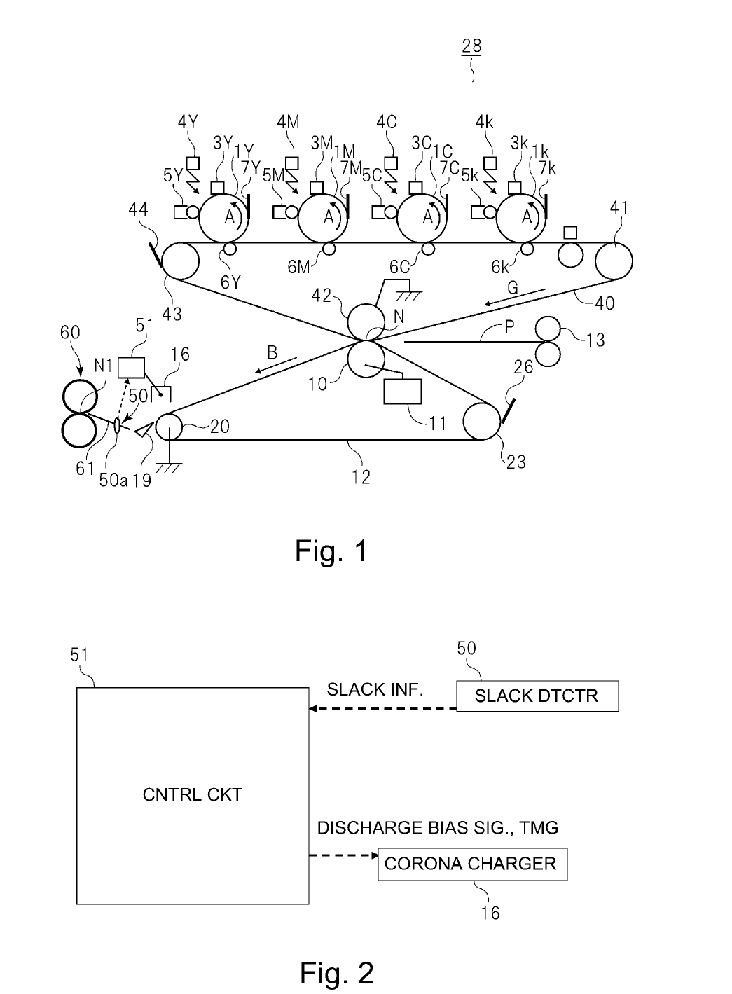

FIG. 1 is a schematic sectional view of the image forming apparatus in this embodiment of the present invention. It shows the general structure of the apparatus.

Referring to FIG. 1, the image forming apparatus 28 has an endless intermediary transfer belt 40, and photosensitive drums 1Y, 1M, 1C and 1K which are positioned in the adjacencies of the intermediary transfer belt 40, in the listed order in terms of the circular movement (indicated by arrow mark G) of the intermediary transfer belt 40. More specifically, they are positioned so that the peripheral surface of each photosensitive drum 1 contacts the intermediary transfer belt 40. The apparatus 28 is structured so that the intermediary transfer belt 40 is suspended and kept stretched by three belt suspension rollers 41, 42, and 43, and is circularly moved in the direction indicated by the arrow mark G, at a preset peripheral velocity which is in a range of 250-300 [mm/sec].

In this embodiment, the belt suspension roller 41 is a tension roller for providing the intermediary transfer belt 40 with a preset amount of tension. The belt suspension roller 42 is a roller which opposes the secondary transfer roller 10 with the presence of the intermediary transfer belt 40 between itself and secondary transfer roller 10. The belt suspension roller 43 is a driving roller for driving the intermediary transfer belt 40. The intermediary transfer belt 40 supported by these belt suspension rollers 41, 42, and 43 is positioned so that it directly opposes all the photosensitive drums 1 (1Y-1K).

In this embodiment, the intermediary transfer belt 40 is made of such resin as poly-imide, poly-carbonate, or one of various rubbers, and a proper amount of carbon black (as charge inhibitor agent). Its volume resistivity is in a range of (1E+9)-(1E+14) Ω·cm. Its thickness is in a range of 0.07-0.10 mm.

The photosensitive drums 1Y, 1M, 1C and 1K are rotationally driven in the direction indicated by an arrow mark A, at a preset peripheral velocity (process speed). As they are rotationally driven, their peripheral surfaces are uniformly charged by primary charging devices 3Y, 3M, 3C and 3k, respectively, to preset polarity and potential level (primary charge).

The laser beam scanner 4Y, 4M, 4C and 4K scan (expose) the uniformly charged portions of the peripheral surfaces of the photosensitive drums 1Y-1K, by outputting a beam of laser light while modulating (turning on or off) the beam according to the information of the image to be formed, which is inputted from an unshown external device such as an image scanner, a computer, etc. Consequently, electrostatic latent images, which reflect the information of the image to be formed, are effected on the peripheral surfaces of the photosensitive drums 1Y-1K, one for one.

The image forming apparatus 28 is provided with developing device 5Y, 5M, 5C and 5K, which are placed in the adjacencies of the photosensitive drums 1Y, 1M, 1C and 1K, respectively. These developing devices 5Y, 5M, 5C and 5K contain color toners, more specifically, yellow (Y), magenta (M), cyan (C) and black (K) toners, respectively. The electrostatic latent images on the peripheral surfaces of the photosensitive drums 1Y-1K are developed (in reverse) with the developers (toners) in the developing devices 5Y, 5M, 5C and 5K, respectively, into visible images (unfixed) made up of yellow, magenta, cyan, and black toners, respectively. The method used for developing the electrostatic latent images is the so-called reversal developing method, which adheres toner to exposed points of an electrostatic latent image.

The unfixed toner images, different in color, on the peripheral surfaces of the photosensitive drums 1Y-1K, one for one, are electrostatically and sequentially (in the listed order) transferred (primary transfer) onto the intermediary transfer belt 40 by the primary transfer rollers 6Y, 6M, 6C and 6K, respectively. Consequently, four unfixed tone images, different in color, are layered on the intermediary transfer belt 40, yielding thereby a full-color image on the intermediary transfer belt 40. Each time the photosensitive drums 1Y, 1M, 1C and 1K are rotated one full turn, their peripheral surfaces are cleaned by the cleaning devices 7Y, 7M, 7C and 7K (toners remaining on peripheral surfaces of photosensitive drums 1 are removed by cleaning devices 7) so that they can be repeatedly used for the following image forming process.

The secondary transfer roller 10 is positioned so that it opposes the belt suspension roller 42 with the presence of the intermediary transfer belt 40 between itself and belt suspension roller 42. The image forming apparatus 28 is structured so that the secondary transfer roller 10 can be separated from the intermediary transfer belt 40. More specifically, while the unfixed toner images are layered on the intermediary transfer belt 40, the secondary transfer roller 10 is not placed in contact with the intermediary transfer belt 40. It is only when the layered toner images on the intermediary transfer belt 40 are transferred (secondary transfer) onto a sheet P of recording medium that the secondary transfer roller 10 is placed in contact with the intermediary transfer belt 40 to form the secondary transfer nip N between itself and intermediary transfer belt 40. Incidentally, the combination of the photosensitive drums 1Y-1K, intermediary transfer belt 40, belt suspension rollers 41, 42 and 43, second transfer roller 10, etc., makes up the image forming means for forming a toner image on the sheet P of recording medium.

The image forming apparatus 28 is provided with an unshown sheet feeder cassette in which multiple sheets P of recording medium (paper) are stored in layers. In response to a signal for starting to feed a sheet P of recording medium into the main assembly of the image forming apparatus 28, the sheet feeding roller of the image forming apparatus 28 begins to be driven, to start feeding, one by one, the sheets P in the sheet feeder cassette into the main assembly of the image forming apparatus 28. Then, each sheet P of recording medium is conveyed by the pair of registration roller 13 in the direction indicated by an arrow mark B, with such a timing that the sheet P arrives at the secondary transfer nip N as the same time as the leading edge of the image on the intermediary transfer belt 40. More specifically, as a sheet P of recording medium is conveyed to the pair of registration rollers 13, it is temporarily held by the registration rollers 13, and then, is released with the above-described timing. As the sheet P arrives at the secondary transfer nip N, it is pinched between the belt suspension roller 42 and secondary transfer roller 10, in the secondary transfer nip N, and bias (transfer bias), which is a voltage controlled in amplitude to a preset level, is applied to the secondary transfer roller 10 from the high voltage power source 11 for the secondary transfer.

As the recording medium conveyance belt 12 is circularly moved in the direction indicated by the arrow mark B, the sheet P of recording medium is conveyed through the secondary transfer nip N formed between the belt suspension roller 42 and secondary transfer roller 10, while the secondary transfer current is flowed through the secondary transfer nip N by the aforementioned bias (transfer voltage) applied to the secondary transfer roller 10. Thus, the four monochromatic toner images, different in color, layered on the intermediary transfer belt 40, making up the full-color image on the intermediary transfer belt 40, are transferred together onto the sheet P of recording medium. At the same time as the full-color image begins to be transferred onto the sheet P, the sheet P is electrostatically adhered to the recording medium conveyance belt by the static electricity supplied to the recording medium conveyance belt 12. After the transfer of the full-color toner image onto the sheet P on the recording medium conveyance endless belt 12, the belt 12 conveys further the sheet P while keeping the sheet P electrostatically adhered to the belt 12.

The image forming apparatus 28 is structured so that the recording medium conveyance belt 12 is suspended and kept stretched by the secondary transfer roller 10, separation roller 20, and belt suspension roller 23, and is circularly moved in the direction indicated by the arrow mark B at a preset speed in a range of 250-300 [mm/sec], for example. Further, the image forming apparatus 28 is provided with a sheet separating claw 19 (separation claw) and the sheet separating roller 20 (separation roller), which make up the sheet separating means which separates a sheet P of recording medium from the recording medium conveyance belt 12 and sends the sheet P toward the fixing device 60.

The recording medium conveyance belt 12 in this embodiment is made of resin, such as poly-imide, poly-carbonate, and the like, or one of various rubbers, and carbon black dispersed as charge inhibitor in the resin by amount proper to yield an endless belt as the recording medium conveyance belt 12 which is in a range of (1E+9)-(1E+14) Ω·cm in volume resistivity.

The recording medium conveyance belt 12 is hard enough for its Young's modulus, measured with the use of a tension testing method (JIS K 6301), to be no less than 100 [MPa] and no more than 10 [Mpa]. Therefore, it can be reliably cleaned with the use of a blade-based cleaning method. More specifically, the toner adhered to the surface of the recording medium conveyance belt 12 to form a test patch during recording sheet intervals, the toner having adhered to the recording medium conveyance belt 12 as a sheet P of recording medium jammed the fixing device 60 as described above, the toner remaining adhered to the recording medium conveyance belt 12 after the secondary transfer, paper dust, and the like unwanted residues, can be physically scraped away with an elastic blade formed of urethane rubber or the like.

In this embodiment, +30-60 [μA], for example, of electric current is flowed as the secondary transfer current. The reason why the secondary transfer current changes in amount is that the amount by which the secondary transfer current needs to flowed is affected by how dry a sheet of recording medium, ambient conditions, the amount of the toner to be transferred, and/or the like factors.

The secondary transfer roller 10 may be such a roller that is made up of a metallic core, and an elastic layer foamed of rubber (NBR rubber) capable of conducting ions. More specifically, it may be a roller which is 24 [mm] in external diameter, 6.0-12.0 [μm] in surface roughness (Rz=6.0-12.0), and (1E+5)-(1E+7) [Ω] in the amount of electrical resistance (measured under N/N condition (23° C. in temperature and 50% in RH) while 2 [kV] of voltage is applied), for example.

After being put through the secondary transfer station, the sheet P of recording medium is conveyed by the recording medium conveyance belt 12 to the separation roller 20, at the location of which the sheet P is separated from the recording medium conveyance belt 12 by the separation claw 19. After the separation of the sheet P, which is bearing an unfixed toner image at this point of the image forming operation, from the recording medium conveyance belt 12, at the location of the separation roller 20, it is conveyed to the fixing device 60, in which the unfixed toner image is fixed to the sheet P. Then, the sheet P is discharged from the main assembly of the image forming apparatus 28.

In terms of the recording medium conveyance direction, the fixing device 60 is positioned on the downstream side of the recording medium conveyance belt 12. It is an image heating means which heats the toner image on a sheet P of recording medium while conveying the sheet P through its fixation nip N1.

The separation claw 19 is positioned on the downstream side of the separation roller 20. It functions as a member that assists the separation roller 20 to separate the sheet P of recording medium from the recording medium conveyance belt 12, and then, conveys the sheet P from the recording medium conveyance belt 12 to the fixing device 60 after the separation of the sheet P from the recording medium conveyance belt 12. The separation roller 20 is made of SUS, for example, and is 12-16 [mm] in external diameter.

The separation roller 20 is grounded (frame-grounded). The image forming apparatus 28 is also provided with the corona-based discharging device 16, which is positioned in the adjacencies of the passage for recording medium, in such a manner that it opposes the separation roller 20 with the presence of the recoding medium passage between itself and the separation roller 20. The corona-based discharging device 16 is made up of a piece of SUS wire which is 0.5 [mm] in diameter, and a grounded SUS plate bent in such a manner that the SUS wire is surrounded from three sides to allow the recording medium conveyance belt 12 to be exposed to the SUS wire. In terms of the recording medium conveyance direction, the SUS wire of the corona-based discharging device 16 is within the range of the separation roller 20. In terms of the direction perpendicular to the recording medium conveyance belt 12, it is 10-20 [mm], for example, apart from the belt 12.

There is a front guide 61 for the fixing device 60, between the separation claw 19 and fixing device 60. The front guide 61 is provided with a slack amount detecting device 50, which has a flag 50a.

In this embodiment, the timing with which the discharge bias voltage is applied to the corona-based discharging device 16 to remove (discharge) the electrostatic charge between a sheet P of recording medium and recording medium conveyance belt 12, and the amplitude of the discharge bias voltage, are controlled by a control circuit 51 as a controlling means. As the discharge bias voltage is applied to the corona-based discharging device 16 (discharging means), it discharges (neutralizes) the electrostatic charge between the recording medium conveyance belt 12 and the sheet P, with the use of the air ions which it generates.

After being separated from the recording medium conveyance belt 12, the sheet P of recording medium is introduced into the fixing device 60, in which the sheet P and the unfixed toner image(s) thereon are subjected to heat and pressure so that the unfixed toner image(s) is fixed to the sheet P. After the secondary transfer, the intermediary transfer belt 40 is cleaned by the belt cleaning device 44; the transfer residual toner, paper dust, and the like contaminants are removed from the intermediary transfer belt 40 by the belt cleaning device 44. Then, the intermediary transfer belt 40 is used for the following image formation process; it is repeatedly used for image formation. As for the recording medium conveyance belt 12, after the separation of the sheet P of recording medium therefrom, the recording medium conveyance belt 12 is cleaned by the belt cleaning device 26; the transfer residual toner, the toner resulting from the control patch formed between recording medium intervals, paper dust, and the like, on the recording medium conveyance belt 12 are removed by the belt cleaning device 26. Then, the recording medium conveyance belt 12 is used for conveying the next sheet P of recording medium; it is repeatedly used for recording medium conveyance.

Next, the control system of the image forming apparatus 28 in this embodiment is described. FIG. 2 is a block diagram of the control system of the image forming apparatus 28 in this embodiment.

Referring to FIG. 2, the control circuit 51 in the image forming apparatus 28 is in connection to the slack amount detecting device 50 and corona-based discharging device 16 (corona-based charging device).

The control circuit 51 is such a controlling means that begins to remove electrical charge from the sheet P of recording medium with the use of the corona-based discharging device 16 (discharging means) after at least the leading edge of the sheet P comes into contact with the fixation nip N1. The control circuit 51 begins to remove electric charge from the sheet P with the use of the corona-based discharging device 16 (as discharging means), only when the amount of slack of the sheet P detected by the slack amount detecting means 50 (as recording medium detecting means) is greater than a preset value.

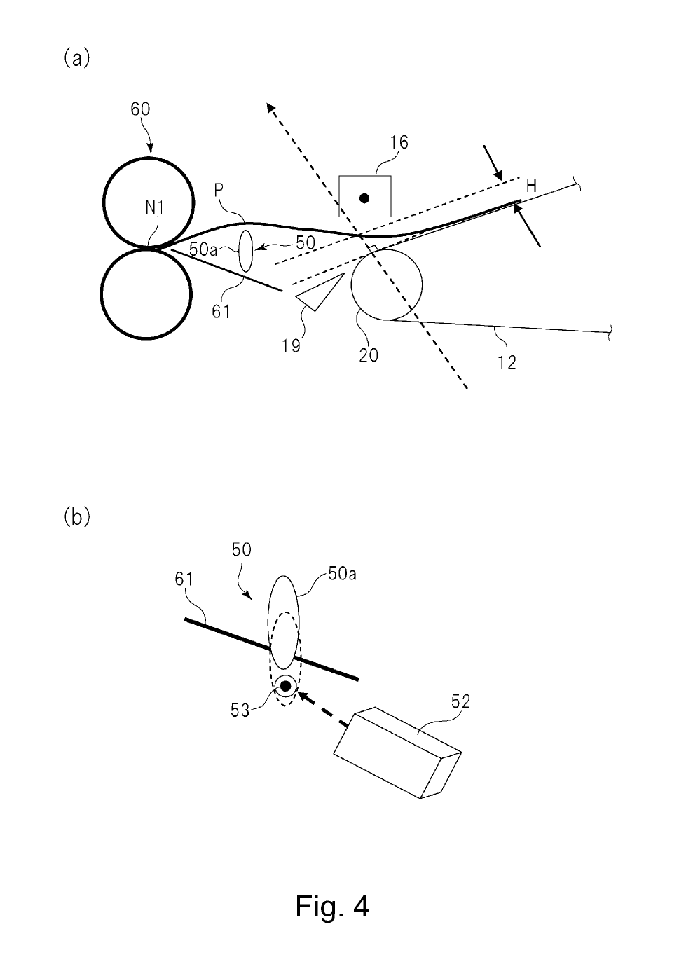

The slack amount detecting device 50 detects the amount of slack of the sheet P of recording medium when the sheet P is between the separation roller 20 and fixing device 60. Referring to FIG. 4(a), the slack amount detecting device 50 is positioned inward of the lateral edges of the front guide 61 for the fixing device 60, in terms of the direction perpendicular to the recording medium passage. It is provided with a flag 50a, which is vertically movable by the pressure which the sheet P applies to the flag 50a as the sheet P is conveyed on the front guide 61.

The amount of slack of the sheet P of recording medium is detected based on the change in the vertical position of the flag 50a. That is, when the sheet P is conveyed along the front guide 61 in such a manner that the entirety of the sheet P remains virtually in contact with the sheet bearing surface of the front guide 61, the sheet P presses the flag 50a downward and keeps the flag 50a low in position, and therefore, the slack amount detecting device 50 determines that the sheet P is small in the slackness. On the other hand, if the sheet P slacks before it begins to be introduced into the fixing device 60, the flag 50a is not likely to be pressed downward by the sheet P as much as when the sheet P does not slack.

Thus, when the flag 50a is allowed to remain high in position, it is determined that the sheet P is large in the slack amount.

The sheet slack amount detecting device 50 functions not only as the means for detecting the point in time at which the leading edge of the sheet P of recording medium has come into contact with the fixation nip N1, but also, as the means for detecting the amount of slack of the sheet P at the moment of contact between the leading edge of the sheet P and fixation nip N1.

The corona-based discharging device 16 is positioned in the adjacencies of the separation claw 19 and separation roller 20 which make up the means for separating the sheet P of recording medium from the recording medium conveyance belt 12. It functions as the means for removing electric charge from the sheet P. The timing with which the discharge bias voltage is applied to the corona-based discharging device 16 in proportion to the amount of slack of the sheet P detected by the sheet slack amount detecting device 50, in order to remove (discharge) the electrostatic charge between the sheet P of recording medium and recording medium conveyance belt 12, and the amplitude of the discharge bias voltage (discharge bias signal), are controlled by the control circuit 51. In terms of the recording medium conveyance direction, the corona-based discharging device 16 as the charge removing means is positioned between the separation claw 19 and separation roller 20 with the presence of a preset distance from the recording medium conveyance belt 12, in such a manner that the open side of its SUS plate faces the recording medium conveyance belt 12.

Referring to FIG. 4(b), the image forming apparatus 28 is provided with a combination of a laser beam source 52 and a laser beam catching device 53 for detecting the position of the flag 50a, which is for determining whether or not the flag 50a of the sheet slack amount detecting device 50 has changed in position by a preset amount. The laser beam source 52 and laser beam catching device 53 determines the amount of the slack of the sheet P of recording medium, based on the principle that when the beam of laser light emitted by the laser beam source 52 is blocked by the flag 50a, the amount of slack of the sheet P is greater than a preset value.

The greater the amount of slack of the sheet P of recording medium, the greater the distance between the sheet P and recording medium conveyance belt 12 at the separation roller 20, and therefore, the greater the possibility that the image forming apparatus 28 will be made to output an unsatisfactory image, the unsatisfactoriness of which is attributable to the “separation discharge”, or the electrical discharge which occurs between the sheet P and recording medium conveyance belt 12 when the sheet P is unexpectedly forced to separate from the recording medium conveyance belt 12. This is why the timing with which the bias voltage is to be applied to the corona-based discharging device 16, and the amount of the bias voltage, are controlled by the control circuit 51, based on the amount of slack of the sheet P detected by the slack amount detecting device 50.

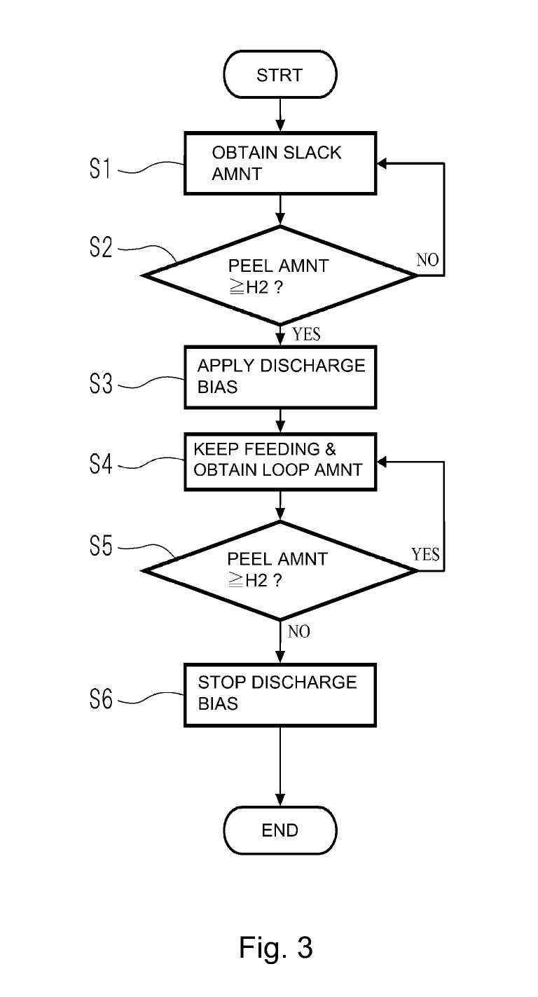

Next, referring to the flowchart in FIG. 3, the effects of this embodiment are described. Prior to the starting of the conveyance of the sheet P of recording medium, the charge removal bias voltage to be applied to the corona-based discharging device 16 is kept turned off. Then, in Step S1, the slack amount detecting device 50 detects the amount of slack of the sheet P when the sheet P is between the separation roller 20 and fixing device 60.

As the sheet P increases in the amount of slack while it is between the separation roller 20 and fixing device 60, the distance H between the point of the recording medium conveyance belt 12 at which the sheet P separates from the recording medium conveyance belt 12 and the sheet P in terms of the direction perpendicular to the top flat portion of the recording medium conveyance belt 12 increases. The greater the distance H (which hereafter will be referred to as “separation distance”), the more likely it is for the image forming apparatus 28 to output an unsatisfactory image, the unsatisfactoriness of which is attributable to the “separation discharge” which occurs when the sheet P is unexpectedly forced to separate from the recording medium conveyance belt 12.

In the case of the image formation system in this embodiment, if the above described “separation distance H” is greater than 8-10 [mm], for example, the system outputted an unsatisfactory image, the unsatisfactoriness of which is attributable to the “separation discharge”. If the timing with which the charge removal bias voltage is applied to the corona-based discharging device 16 is after the separation distance H grows to be no less than 8 [mm], it is impossible to prevent the image formation system from outputting an unsatisfactory image, the unsatisfactoriness of which is attributable to the separation discharge. In this embodiment, therefore, it is assumed that if the separation distance H exceeds a distance H2 which is smaller than 8 mm, the image formation system has to be prepared to be prevented from outputting an unsatisfactory image, the unsatisfactoriness of which is attributable to the separation discharge. In this embodiment, the distance H2 is set to 5 [mm].

If the control circuit 51 determines that the amount of slack of the sheet P is large enough to block the beam of light emitted by the laser beam source 52 (FIG. 4(b)), it sets the value for the separation distance H, assuming that the separation distance H is no less than the distance H2.

The relation between the amount of slack of the sheet P detected by the sheet slack amount detecting device 50, and the separation distance H, is affected by where the sheet slack amount detecting device 50 is positioned relative to the separation roller 20. Therefore, the positioning of the laser beam source 52 and laser beam receiving device 53 of the sheet slack amount detecting device 50 has to be decided in advance, that is, during the designing phase of the apparatus 28, so that the separation distance H2 can be detected.

In Step S2, as soon as the leading edge of the sheet P of recording medium reaches the separation roller 20, the control circuit 51 determines whether the separation distance H is no less than H2 (amount of sheet slack is no less than preset value) or no more than H2, based on the amount of slack of the sheet P detected by the sheet slack amount detecting device 50.

If the separation distance H at the separation roller 20 is no more than H2, the control circuit 51 continues to convey the sheet P while checking the amount of slack of the sheet P. If the separation distance H at the separation roller exceeds H2, the control circuit 51 applies the charge removal bias voltage to the corona-based discharging device 16 (corona-based charging device) to remove the electrical charge between the sheet P and recording medium conveyance belt 12 (S3). From the standpoint of efficiently and uniformly remove the electrical charge with the use of the corona-based discharging device 16, it is desired that the AC voltage to be applied as the electrical charge removal bias to the corona-based discharging device 16 is greater in amplitude than a certain value.

In this embodiment an AC voltage which is 100 Hz-1 kHz in frequency, 6-12 kV in peak-to-peak voltage (Vpp), is applied as the electrical charge removal bias voltage to the corona-based discharging device 16.

Thereafter, in Step S4, the control circuit 51 monitors the amount of slack of the sheet P by obtaining the information regarding the amount of slack of the sheet P while continuing to convey the sheet P.

Next, in Step S5, the control circuit 51 determines whether or not the separation distance H at the separation roller 20 is no less than H2. If the separation distance H at the separation roller 20 is no less than H2, the control circuit 51 continues to convey the sheet P while applying the charge removal bias voltage to the corona-based discharging device 16. On the other hand, if the separation distance H is no more than H2, the control circuit 51 turns off the charge removal bias voltage to be applied to the corona-based discharging device 16 (corona-based charging device) (S6).

In this embodiment, the charge removal bias voltage to be applied to the corona-based discharging device 16 is turned off (S6) if the separation distance H is no more than H2. However, this embodiment is not intended to limit the present invention in terms of the value of H2. For example, instead of turning off the charge removal bias voltage, the charge removal bias voltage may be reduced to such a level that does not excessively reduce the electrostatic force which keeps the sheet P adhered to the recording medium conveyance belt 12.

As described above, in this embodiment, the control circuit 51 (controlling means) begins to remove electrical charge from the sheet P after at least the leading edge of the sheet P of recording medium comes into contact with the fixation nip N1 of the fixing device 60 and the contact between the sheet P and fixation nip N1 begins to cause the sheet P to slack. That is, it is before the starting of the fixation of the toner image(s) on the sheet P that the control circuit 51 detects, with the use of the sheet slack amount detecting device 50, the amount of the slack in which the sheet P bends as it comes into contact with the fixation nip N1. Further, it is only when the separation distance H is no less than H2, in other words, only when it is possible for the image forming apparatus 28 to output an unsatisfactory image, the unsatisfactoriness of which is attributable to the separation discharge, that the control circuit 51 applies the charge removal bias voltage to the corona-based discharging device 16 to remove electrical charge from the sheet P.

Therefore, it is possible to minimize the amount by which the electrostatic force generated between the sheet P of recording medium and recording medium conveyance belt 12 to ensure that the sheet P is satisfactorily conveyed by the recording medium conveyance belt 12, is reduced by the charge removal bias voltage applied to the corona-based discharging device 16. Therefore, it is possible to ensure that while the sheet P is conveyed from the point of separation between the sheet P and recording medium conveyance belt 12 to the fixing device 60, the sheet P remains in such an attitude that does not causes the sheet P to jam the fixing device 60 (image forming apparatus 28). Moreover, the removal of electrical charge from the sheet P by the corona-based discharging device 16 prevents the occurrence of the separation discharge, the occurrence of which is attributable to the attitude in which the sheet P is when the sheet P is unexpectedly forced to separate from the recording medium conveyance belt 12 at the separation roller 20. Therefore, this embodiment can ensure that the image forming apparatus 28 does not output an unsatisfactory image, the unsatisfactoriness of which is attributable to the separation discharge.

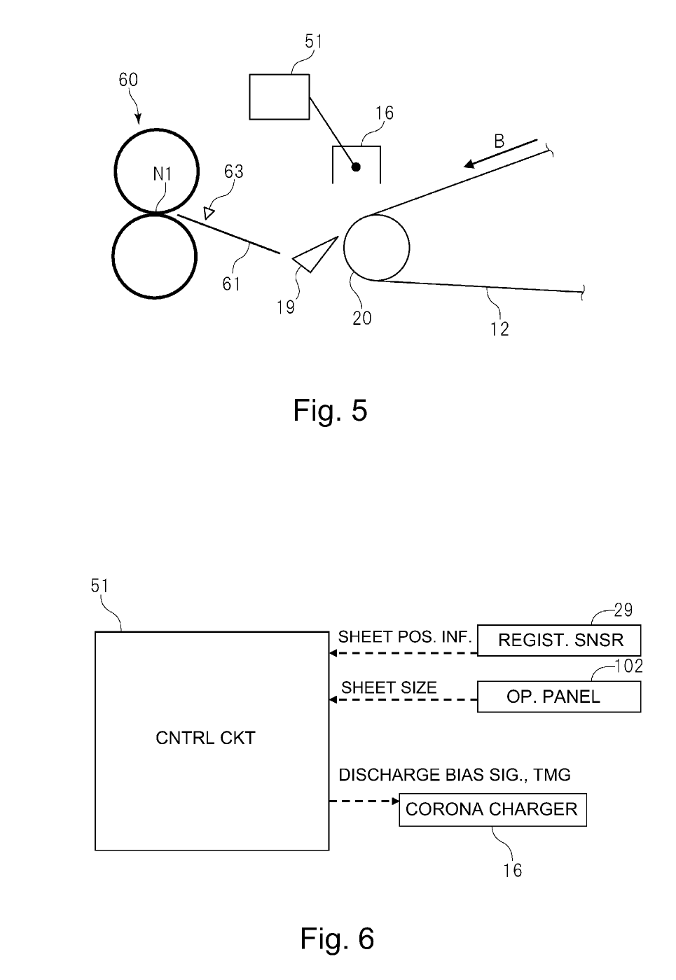

In this embodiment, whether or not the leading edge of the sheet P of recording medium has reached the fixing device 60 was indirectly determined with the use of the sheet slack amount detecting device 50. However, this embodiment is not intended to limit the present invention in terms of the method for determining the timing of the arrival of the sheet P at the fixing device 60. For example, the image forming apparatus 28 may be structured as shown in FIG. 5. That is, the image forming apparatus 28 may be structured so that the arrival of the leading edge of the sheet P at the fixation nip N1 of the fixing device 60 is directly detected by a recording medium detection sensor 63 positioned above the front sheet guide 61 for the fixing device 60 as shown in FIG. 5. The application of the present invention to an image forming apparatus structured as shown in FIG. 5 results in the same effects as those of the first embodiment. Further, in place of this recording medium detection sensor 63, an instrument such as a laser-based displacement gauge may be positioned above the front sheet guide 61.

### Embodiment 2

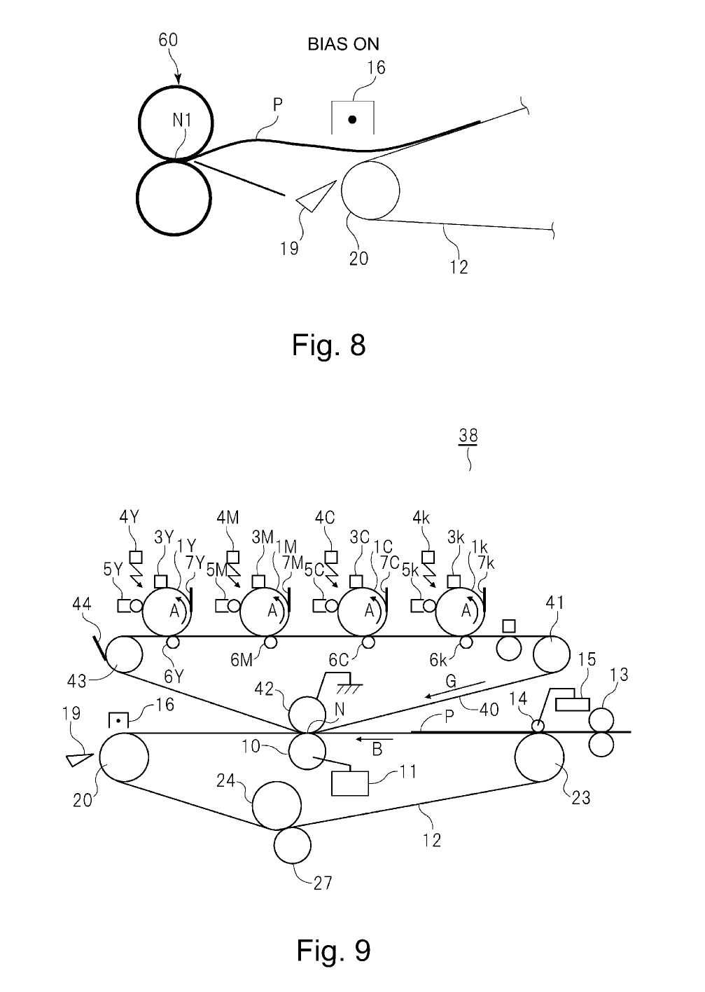

Next, referring to FIGS. 6-8, the second embodiment of the present invention is described.

In the first embodiment of the present invention described above, it was based on the amount of slack of the sheet P of recording medium detected by the slack amount detecting device 50 that the control circuit 51 controlled the charge removal bias voltage which was to be applied to the corona-based discharging device 16. However, it is after the entrance of the leading edge of the sheet P into the fixation nip N1 of the fixing device 60 that the sheet P begins to increase in the slackness. Thus, the amount of increase in the slack of the sheet P can be predicted from the information regarding the position of the sheet P while the sheet P is conveyed. In other words, providing the image forming apparatus 28 with the slack amount detecting device 50 is not mandatory to control the charge removal bias voltage to be applied to the corona-based discharging device 16. That is, it is possible for the control circuit 51 to control the charge removal bias voltage to be applied to the corona-based discharging device 16, based on the information regarding the position of the sheet P while the sheet P is conveyed for image formation. In this embodiment, therefore, the control circuit 51 controls the charge removal bias voltage to be applied to the corona-based discharging device 16, by predicting the amount of the growth of the slack of the sheet P.

The structure of the image forming apparatus in the second embodiment is roughly the same as that of the image forming apparatus 28 shown in FIG. 1. Further, the image formation process used by the image forming apparatus in this embodiment also is the same as the one used by the image forming apparatus 28 in the first embodiment. However, the image forming apparatus in this embodiment predicts (detects) the amount of the slack of the sheet P, based on the positional information of the sheet P. Therefore, it is not provided with the sheet slack amount detecting device 50 with which the image forming apparatus 28 in the first embodiment was provided.

Also in this embodiment, the timing with which the discharge bias voltage is applied to the corona-based discharging device 16 to remove (discharge) the electrostatic charge between a sheet P of recording medium and recording medium conveyance belt 12, and the amplitude of the charge removal bias voltage, are controlled by a control circuit 51. FIG. 6 is a block diagram which shows the relationship among the components of the image forming apparatus in this embodiment which are involved in this control.

Referring to FIG. 6, the control circuit 51 is in connection to a registration sensor 29 which is capable of obtaining various information, including the position of the sheet P of recording medium after the occurrence of the contact between the sheet P and the nip of the pair of registration rollers 13. Further, the control circuit 51 is in connection to the control panel 102 (unshown in FIG. 1) with which the main assembly of the image forming apparatus 28 is provided, and a corona-based discharging device (corona-based charging device) which is similar to the one in the first embodiment.

The control panel 102 outputs to the control circuit 51, such information as the recording medium size inputted by a user or the like.

The registration sensor 29 detects the leading and trailing edge of the sheet P of recording medium, and the timing with which the sheet P begins to be conveyed after being temporarily held up by the nip of the pair of registration rollers 13. Then, it outputs the signals which indicate the point in time at which the leading and trailing edges of the sheet P arrived at the registration sensor 29, and the signals which indicate the timing with which the sheet P began to be conveyed by the pair of registration rollers 13.

The control circuit 51 determines the position of the sheet P, based on the information sent from the registration sensor 29, and the length of the sheet P, in terms of the recording medium conveyance direction, sent out by the registration rollers 13. The registration sensor 29 in this embodiment is a recording medium detecting means structured so that it can predict (detect) the point in time at which the leading edge of the sheet P will come into contact with the fixation nip N1.

That is, the control circuit 51 obtains not only the information regarding the position of the sheet P, based on the length of the sheet P sent from the registration rollers 13, but also, the information regarding the size of the sheet P of recording medium selected by a user through the control panel 102. The control circuit 51 as a controlling means begins to remove electric charge from the sheet P with the use of the corona-based discharging device 16 (discharging means), in response to the signals sent from the registration sensor 29.

That is, the control circuit 51 predicts the amount of the growth of the slack of the sheet P which occurs after at least the leading edge of the sheet P comes into contact with the fixation nip N1, based on the positional information regarding the leading and trailing edges of the sheet P. Then, the control circuit 51 decides the timing with which the charge removal bias voltage (charge removal bias signal) is to be applied to the corona-based discharging device 16, and the amplitude of the voltage. Then, it controls the corona-based discharging device 16.

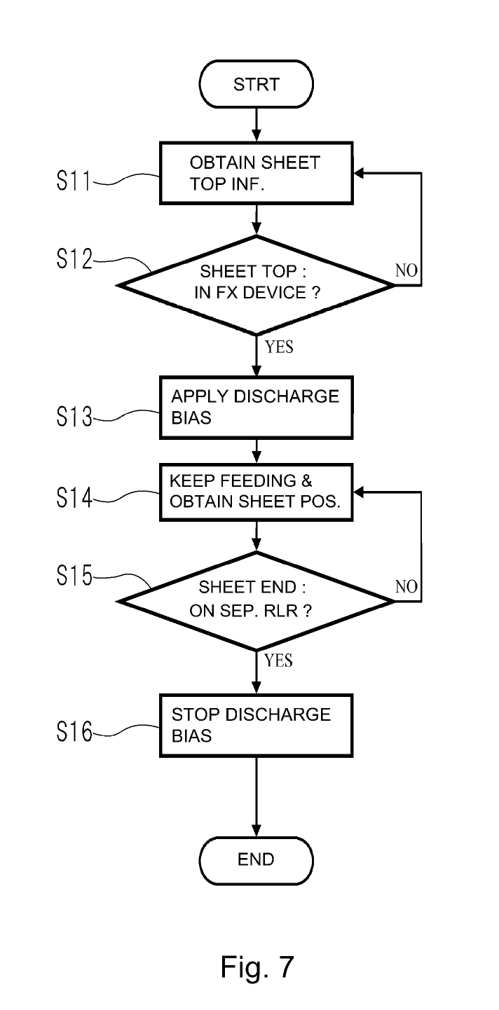

Next, referring to the flowchart in FIG. 7, the charge removal operation in this embodiment, and its effects, are described. Prior to the starting of the conveyance of the sheet P, the charge removal bias voltage to be applied to the corona-based discharging device 16 is kept turned off. The registration sensor 29 is in one of the registration rollers 13. The control circuit 51 obtains the information regarding the position of the leading edge of the sheet P which is being conveyed by the registration rollers 13, based on the signal sent from the registration sensor 29 (S11).

Then, as the leading edge of the sheet P enters the fixation nip N1 of the fixing device 60, the speed at which the leading edge portion of the sheet P is conveyed becomes slower than the speed at which the trailing end portion of the sheet P is conveyed, because the fixation nip N is less in the recording medium conveyance speed than the secondary transfer nip N. Therefore, the sheet P begins to be pushed by the secondary transfer nip N. Consequently, the portion of the sheet P, which is on the upstream side of the fixing device 60, that is, the portion of the sheet P which is being pushed by the secondary transfer nip N increases in slackness (S12).

As the sheet P increases in slackness, the separation distance H, that is, the distance between the sheet P and recording medium conveyance belt 12 at the separation roller 20, increases, making it possible for the image forming apparatus 28 to be made to form an unsatisfactory image, the unsatisfactoriness of which is attributable to the separation discharge. Therefore, the timing with which the charge removal bias voltage is to be applied to the corona-based discharging device 16 (corona-based charging device) is decided based on the information regarding the point in time at which the sheet P begins to enter the fixation nip N1, that is, the point in time at which the sheet P begins to increase in the slackness (S13).

As long as the leading edge of the sheet P has not begun to enter the fixing device 60, the control circuit 51 continues to convey the sheet P while continuing to obtain the information regarding the position of the leading edge of the sheet P (S14). Then, as soon as the leading edge of the sheet P begins to enter the fixation nip N1 of the fixing device 60, the control circuit 51 begins to apply the charge removal bias voltage to the corona-based discharging device 16 (S13). The charge removal bias voltage in this embodiment is an AC voltage which is 100 Hz-1 kHz in frequency and 6-12 kV in peak-to-peak voltage (Vpp) (S13).

Thereafter, the control circuit 51 continues to convey the sheet P while obtaining the information regarding the position of the trailing edge of the sheet P (S14). The control circuit 51 determines the position of the trailing edge of the sheet P, based on the information regarding the length of the sheet P sent by the registration rollers 13, and the dimension, in terms of the recording medium conveyance direction, of the sheet P selected by the user through the control panel 102. Then, the control circuit 51 determines whether or not the trailing edge of the sheet P has moved past the separation roller 20, that is, whether or not the trailing edge of the sheet P has separated from the recording medium conveyance belt 12 (S15).

### [Reason why Decision is Made Based on Position of Trailing Edge of Sheet P of Recording Medium]

When the trailing edge of the sheet P has not moved past the separation roller 20, the control circuit 51 continues to convey the sheet P while applying the charge removal bias voltage to the corona-based discharging device 16 (S14). As soon as the trailing edge of the sheet P moves past the separation roller 20, that is, as soon as the trailing edge of the sheet P separates from the recording medium conveyance belt 12, the control circuit 51 turns off the charge removal bias voltage to be applied to the corona-based discharging device 16 (corona-based charging device), and prepares the recording medium conveyance belt 12 for the next sheet P of recording medium (S16).

As described above, in this embodiment, the control circuit 51 predicts the point in time at which the leading edge of the sheet P will come into contact with the fixation nip N1, based on the signal sent from the registration sensor 29, and then, predicts the amount of growth of the slack of the sheet P, before the leading edge of the sheet P reaches the fixation nip N1. Then, the control circuit 51 begins to apply the charge removal bias voltage to the corona-based discharging device 16, with the predicted point in time at which that the leading edge of the sheet P will reach the fixation nip N1. Therefore, this embodiment can ensure that the sheet P is reliably conveyed, and therefore, can minimize the amount by which the electrostatic force which keeps the sheet P adhered to the recording medium conveyance belt 12 is reduced by the application of the charge removal bias voltage to the sheet P.

Therefore, the sheet P is satisfactorily controlled in attitude while being conveyed between the point at which the sheet P separates from the recording medium conveyance belt 12 and the fixing device 60. Therefore, the sheet P is prevented from jamming the fixing device 60 (image forming apparatus 28). Moreover, electrical charge is removed from the sheet P by the corona-based discharging device 16. Therefore, this embodiment can effectively prevent the “separation discharge”, that is, the electrical discharge which occurs between the sheet P and recording medium conveyance belt 12 when the sheet P separates from the recording medium conveyance belt 12 on the upstream side of the separation roller 20 in terms of the recording medium conveyance direction, and which is attributable to the attitude (slack) of the sheet P.

As described above, in this embodiment, the image forming apparatus 28 is structured so that electric charge is removed from the sheet P not only when the sheet P is greater in slack than a preset value, as in the first embodiment, but also, the removal of electric charge from the sheet P is always started with the predicted timing with which the leading edge of the sheet P will enter the fixation nip N1. That is, unlike in the first embodiment, in this embodiment, electrical charge is removed from the sheet P even when the sheet P is small enough in slack to make it unnecessary for electrical charge to be removed from the sheet P. On the other hand, in this embodiment, the registration sensor 29 and control panel 102, with which most image forming apparatuses are provided, are effectively utilized to control the operation to remove electrical charge from the sheet P. In other words, the second embodiment is simpler in the structure of the image forming apparatus 28 than the first embodiment in which the image forming apparatus 28 is provided with the sheet slack amount detecting device 50, that is, a device dedicated to the detection of the amount of slack of the sheet P.

### <Comparative Image Forming Apparatus>

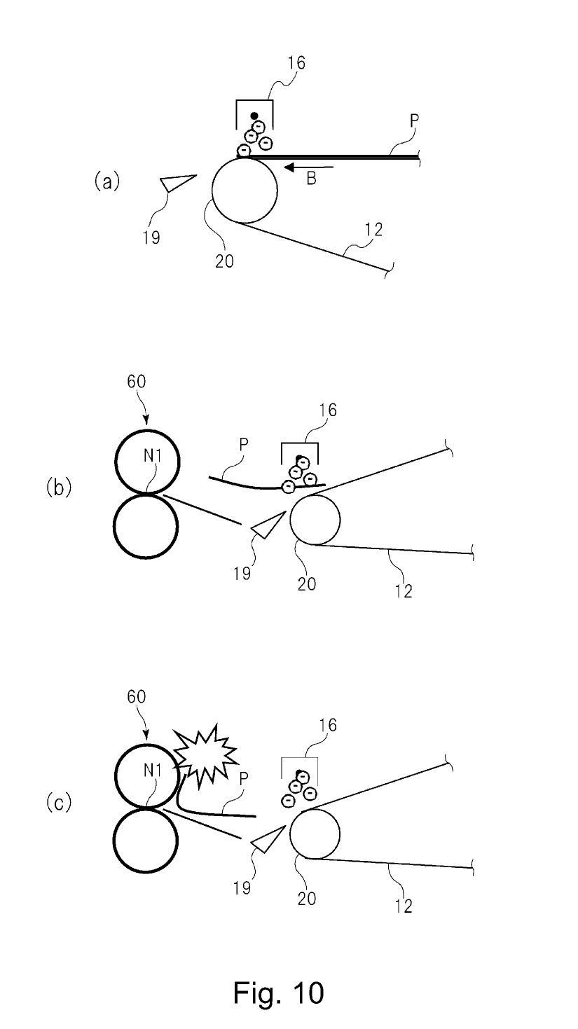

At this time, referring to FIGS. 9 and 10, an image forming apparatus comparable to those in the first and second embodiments are described. FIG. 9 is a schematic sectional view of the image forming apparatus comparable to those in the first and second embodiments.

The recording medium conveyance belt 12 with which the image forming apparatus 38 shown in FIG. 9 is provided is slightly different in structure from the one shown in FIG. 1. More specifically, in the case of this image forming apparatus 38, the separation roller 20 and belt suspension roller 23, by which the recording medium conveyance belt 12 is suspended, are at the same level as the secondary transfer roller 10. That is, the top portion of the recording medium conveyance belt 12, which is in contact with the separation roller 20, secondary transfer roller 10, and belt suspension roller 23, is straight and horizontal. Further, unlike in the first and second embodiments, the corona-based discharging device 16 of this image forming apparatus 38, which is in the adjacencies of the top side of the separation roller 20, is not controlled with such a timing that is proper for removing electric charge from the sheet P of recording medium while a certain portion of the sheet P is between the separation roller 20 and fixation nip N1.

Further, the pair of registration rollers 13 of this image forming apparatus 38 are positioned on the right-hand side of the belt suspension roller 23, and diagonally upward of the belt suspension roller 23. Further, the image forming apparatus 38 is provided with an adhesion roller 14, which is kept pressed against the belt suspension roller 23, with the presence of the recording medium conveyance belt 12 between itself and the belt suspension roller 23, and to which bias voltage is applied from a high voltage power source 15. The image forming apparatus 38 is structured so that the portion of the recording medium conveyance belt 12, which is below the secondary transfer roller 10, remains pinched by the belt suspension roller 24 and a roller 27.

The recording medium conveyance of the image forming apparatus 38 is as follows. As a sheet P of recording medium is released and conveyed by the registration rollers 13, it is pinched by the belt suspension roller 23, and the belt adhesion roller 14 to which bias voltage is being applied. Thus, the sheet P is adhered to the recording medium conveyance belt 12. Further, the sheet P is released and conveyed by the registration rollers 13 with such a timing that the arrival of the sheet P at the secondary transfer nip N will synchronize with the arrival of the leading edge of the image on the intermediary transfer belt 40 at the secondary transfer nip N.

Then, as the sheet P begins to enter the fixing device 60 (FIG. 10(b)) after it separates from the recording medium conveyance belt 12, the sheet P is subjected to such force that is generated in the fixation nip N1 in the direction to move the sheet P forward. If the trailing portion of the sheet P remains in the secondary transfer nip N when the sheet P begins to enter the fixing device 60, that is, when the sheet P begins to be subjected to the above described force in the fixation nip N1, and the recording medium conveyance speed of the fixing device 60 is greater than the recording medium conveyance speed of the secondary transfer nip N, the sheet P is pulled by the fixing device 60. Thus, the sheet P is subjected to a substantial amount of shock at the moment when the leading edge of the sheet P enters the fixing device 60 while the trailing portion of the sheet P is still in the secondary transfer nip N. Consequently, the unfixed toner image on the sheet P is disturbed by the shock. Thus, the image forming apparatus 38 ends up outputting an unsatisfactory image, the unsatisfactoriness of which is attributable to the shock to which the sheet P was subjected when the leading edge of the sheet P entered the fixing device 60.

One of the methods for preventing the image forming apparatus 38 from outputting an unsatisfactory image, the unsatisfactoriness of which is attributable to the shock to which the sheet P is subjected when the leading edge of the sheet P enters the fixing device 60 is to structure the image forming apparatus 38 so that the distance between the secondary transfer nip N and fixing device 60 is sufficiently longer than the dimension of the sheet P in terms of the recording medium conveyance direction. In some cases, however, it is impossible to structure the image forming apparatus 38 so that the distance between the secondary transfer nip N and fixing device 60 is long enough as described above. In such cases, all that is necessary is to structure the image forming apparatus 38 so that the secondary transfer nip N is greater in recording medium conveyance speed than the fixing device 60.

With the image forming apparatus 38 being structured so that its secondary transfer nip N is greater in the recording medium conveyance speed than the fixing device 60, the sheet P is conveyed as if it is pushed into the fixing device 60 by the secondary transfer nip N. Therefore, the sheet P is not subjected to the shock to which it is subjected when its leading edge enters the fixing device 60 in a case where the image forming apparatus 38 is structured so that its fixing device 60 is greater in recording medium conveyance speed than its secondary transfer nip N. However, in the case where the image forming apparatus 38 is structured so that the sheet P is conveyed as if it is pushed into the fixing device 60 by the secondary transfer nip N, the sheet P increases in slack because the sheet P is continuously pushed by the secondary transfer nip N at a speed greater than the speed at which the sheet P is pulled into the fixation nip N1. Therefore, in the case of an image forming apparatus, such as this image forming apparatus comparable to those in the first and second embodiments, that is structured so that the outputting of an unsatisfactory image, the unsatisfactoriness of which is attributable to the above described shock, attention has to be paid not to allow the bending of the sheet P in slack to cause an unexpected problems.

In the case of an image forming apparatus such as this image forming apparatus 38 structured so that recording medium is kept electrostatically adhered to the recording medium conveyance belt 12 while the recording medium is conveyed, and also, so that the recording medium is pushed into the fixing device 60 by the secondary transfer nip N in order to prevent the image forming apparatus from being made to output an unsatisfactory image, the unsatisfactoriness of which is attributable to the shock to which the recording medium is subjected at the moment when the recording medium is pulled into the fixing device 60, the recording medium which has been electrostatically adhered to the recording medium conveyance belt 12 increases in slackness after it begins to be pushed into the fixing device 60 by the secondary transfer nip N. Eventually, it suddenly peels away from the recording medium conveyance belt 12.

As the recording medium suddenly peels away from the recording medium conveyance belt 12, the electric charge which has been keeping the sheet P of recording medium electrostatically adhered to the recording medium conveyance belt 12 triggers the “separation discharge”. There is a significant relationship between the amount of this “separation charge” and the attitude in which the sheet P is when the sheet P is forced to separate from the recording medium conveyance belt 12 by its slack, on the upstream side of the separation roller 20 in terms of the recording medium conveyance direction. That is, as the sheet P is forced to separate from the recording medium conveyance belt 12 by its slack created as described above, the distance between the sheet P and recording medium conveyance belt 12 suddenly increases. Consequently, electrical discharge (“separation discharge”) which is large enough to disturb the toner image on the sheet P occurs, creating thereby a problem that the image forming apparatus is significantly reduced in image quality.

In order to prevent this problem, this image forming apparatus comparable to those in the first and second embodiments is structured (as shown in FIG. 10(b)) so that the electric charge which keeps the sheet P of recording medium electrostatically adhered to the recording medium conveyance belt 12, and also, is the primary cause of the “separation discharge”, is reduced by the activation of the corona-based discharging device 16 shown in FIG. 9. In the case of this comparative image forming apparatus, however, the electric charge which keeps the sheet P of recording medium adhered to the recording medium conveyance belt 12 is simply reduced by the corona-based discharging device 16, that is, without controlling the corona-based discharging device 16 in the timing with which the corona-based discharging device 16 is turned on or off, and the amount by which electrical charge removal bias voltage is applied to the corona-based discharging device 16. Therefore, the electrostatic force which keeps the sheet P adhered to the recording medium conveyance belt 12 may be reduced by an unnecessarily large amount, and also, with wrong timing.

With the electrostatic force which keeps the sheet P adhered to the recording medium conveyance belt 12 reduced by an unnecessarily large amount and/or with wrong timing, the sheet P separates from the recording medium conveyance belt 12 as shown in FIG. 10(b). Thus, if the recording medium used for image formation is a sheet P of recording medium, which is not large enough in size to bridge between the second transfer nip N and fixing device 60, the recording medium cannot be reliably conveyed from the secondary transfer nip N to the fixing device 60. If the sheet P enters the fixation nip N1 of the fixing device 60 while it is in the condition shown in FIG. 10(b), the sheet P cannot be control in attitude by the image forming apparatus. Therefore, it is possible that the sheet P will jam the fixing device 60 (image forming apparatus) as shown in FIG. 10(c).

Compared to this image forming apparatus comparable to those in the first and second embodiments, in the cases of the image forming apparatuses in the first and second embodiments, their control circuits 51 begin to remove electric charge from the sheet P of recording medium with the use of the corona-based discharging device 16 after at least the leading edge of the sheet P comes into contact with the fixation nip N1. Therefore, even if the sheet P of recording medium used for image formation is such that its dimension in terms of the recording medium conveyance direction is less than the distance between the secondary transfer nip N and fixation nip N, the image forming apparatus can reliably convey the sheet P. Therefore, it is ensured that the image forming apparatus is not jammed by a small (short) sheet P of recording medium.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 129811/2012 filed Jun. 7, 2012 which is hereby incorporated by reference.

What is claimed is:

1. An image forming apparatus comprising:
an image forming portion for forming a toner image on a recording material;
an endless recording material feeding belt for electrostatically attracting and carrying the recording material having a toner image;
an image heating member for receiving the recording material from said recording material feeding belt and for heating the toner image on the recording material while nipping and feeding the recording material;
a separation roller for stretching said recording material feeding belt and for separating the recording material from said recording material feeding belt and directing the recording material toward said image heating means;
an electrical discharging member, provided at a position opposing said separation roller through said recording material feeding belt therebetween, for removing charge of the recording material; and
a controller for controlling said discharging means to operate for discharging of the recording material after a leading end of the recording material is brought into abutment to the nip.

2. An apparatus according to claim 1, further comprising a recording material detecting member for detecting abutment of the leading end to the nip and for detecting a amount of slack of the recording material, wherein said controller starts to operate said electrical discharging member when the amount of the slack detected by said recording material detecting member is not less than a predetermined amount.

3. An apparatus according to claim 2, wherein said controller continues detecting the amount of slack after the abutment of the leading end of the recording material to the nip, and wherein when the detected amount of slack is not less than the predetermined amount, said controller continues operation of said electrical discharging member, and when the detected amount of slack is less than the predetermined amount, said controller weakens or stops discharging of the recording material.

4. An apparatus according to claim 1, further comprising a recording material detecting member, provided at a position upstream of said nip in a feeding path for the recording material, for detecting a leading end of the recording material, wherein said controller starts operation of said electrical discharging member on the basis of a result of detection of the recording material detecting member.

5. An apparatus according to claim 4, wherein said controller changes a discharging amount for the recording material by said electrical discharging member on the basis of the result of detection of said recording material detecting member.

6. An apparatus according to claim 4, further comprising an operating portion to which information relating to a size of the recording material is capable of being inputted, wherein said controller continues the operation of said electrical discharging member at least until a trailing end of the recording material passes said separation roller, on the basis of a result of detection of the detecting member.

7. An apparatus according to claim 4, wherein further comprising a feeding member, provided downstream with respect to a recording material feeding direction of the recording material feeding belt, for feeding the recording material to said recording material feeding belt at predetermined timing, wherein said recording material detecting member is disposed downstream of said feeding member with respect to the recording material feeding direction.

8. An apparatus according to claim 1, wherein a speed at which the recording material is fed by said recording material feeding belt is higher than a speed at which the recording material is fed by said image heating member.

9. An apparatus according to claim 1, wherein said electrical discharging member includes a corona discharger disposed opposed to said separation roller through said recording material feeding belt with a predetermined gap.

10. An apparatus according to claim 9, wherein said corona discharger is capable of being supplied with an AC voltage, and said separation roller is electroconductive and is connected with a ground potential.

11. An apparatus according to claim 1, further comprising a separation claw, opposed to said separation roller through said recording material feeding belt, for assisting separation of the recording material from said recording material feeding belt at a position downstream of said corona discharger with respect to the feeding direction of the recording material.
